(19) United States
(12) Patent Application Publication
(10) Pub. No.: US 2022/0110418 A1
(43) Pub. Date: Apr. 14, 2022

(54) Neckwear Fastening Accessory

(71) Applicants: Bradley Jerome LaPointe, (US); David Gilbert Sime, (US)

(72) Inventors: Bradley Jerome LaPointe, Pahrump, NV (US); David Gilbert Sime, Minnetonka, MN (US)

(73) Assignee: Bradley Jerome LaPointe, Pahrump, NV (US)

(21) Appl. No.: 17/475,042

(22) Filed: Sep. 14, 2021

Related U.S. Application Data
(60) Provisional application No. 63/077,861, filed on Sep. 14, 2020.

(51) Int. Cl. A44B 6/00; A41D 25/02

(52) U.S. Cl. CPC A44B 6/00; A41D 23/00; A41D 25/022

(57) ABSTRACT

Embodiments are described of an object designed as an accessory to neckwear which is a substitute for a knot and which is able to display promotional and other information. Embodiments are described which can be easily and economically prepared using widely available printing and converting equipment

### FIELD

The embodiments described are of an object or accessory which can substitute for a knot traditionally used to fasten a necktie or scarf. In particular, the embodiments are of an accessory for neckwear (necktie or neck scarf/bandana) which can substitute for a knot and which can enhance the appearance of the neckwear and can display graphic information or a message such as may be used for promotional purposes.

### BACKGROUND

An individual's appearance or comfort is often enhanced by the use of neckwear, often in the form of a necktie or scarf draped around the neck and held in place with a knot or other fastening lying at the base of the neck, just above the top of the sternum. The necessary skill to make such a knot is held by relatively few people. In addition, the presence of the knot in such a prominent location demands that the knot is well executed. The prominent location also allows any substitute for that knot, such as the one described herein, to assume a major role in the individual's appearance, and offers an opportunity to make an impact in the form of an image or message to covey information, feelings, or desires to the observer. In addition, the use of such a substitute allows the final presentation of the tie or scarf to be made with a single attempt, and eliminates the scenario of multiple attempts at tying a tie or scarf to obtain a properly tied tie or scarf, with the resulting loss of freshness in its appearance. Its use eliminates the requirement of being able to tie a neck tie or scarf, a skill which is not universally held.

The accessory can be formed and/or decorated to complement or contrast with the necktie being used. It can be decorated with purely fashion-oriented designs, or can bear other information. Its simple design and construction allow the cost to be sufficiently low that these accessories can also be used as one-time use objects for promotional or other transient functions.

The use of a neck decoration covering or overlying a shirt or blouse or even worn simply around the neck generally requires a device to tie or retain the neck covering so that it sits in place and does not come loose while being worn. Gentlemen's fashion has often dictated the tying of a particular knot (e.g., an Ascot, or a Windsor knot) for neckwear. Less formal wear, such as a bandana is generally held with a square knot or other simple artifice to retain the scarf in place. In the case of more casual wear, often a rigid device in the form of a short cylinder has been used. Such devices have often been made highly decorative to respond to the dictates of style or fashion and are often referred to as “slip-ons.” In more functional cases, a similar device is used to retain a neckerchief or scarf indicating rank, affiliation or function. In the case of Boy Scout or Girl Scout life the device is often called a woggle, or neckerchief slide. These devices have been reined and generalized in a number of patents.

The device described herein represents a functional development of the idea which is distinguished in simplicity, generality and the use of modern materials which enable a wider and more varied application.

### SUMMARY

Embodiments of the device described include a shaped strip made from flexible material and which can be folded or formed around a neck-tie or scarf, near the wearer's neck, and take the apparent form and function of the conventionally used knot. At each of the ends of said strip, a means is built in to attach one end to the other, thereby providing closure of the device around the necktie. Such an embodiment also includes a body area between the two ends of the strip onto which a graphic design can be applied for display. This graphical design or information is positioned so that is visible on the outside surface of the object when the object is in place.

An embodiment is made from flexible substrate onto which a graphic image can be deposited, and which can be folded or curved around a neck tie or scarf around the neck to retain the tie in place and either substituting for or providing a decorative cover for a conventional knot. The closure mechanism allows the opportunity to adjust without tying or re-tying using the integrated friction inter-lock. The design also offers the opportunity to change appearance at the knot area without changing the tie or scarf. While its full function can be to replace the knot, it can also be used simply to cover, support, hide, or change the appearance of the knot.

Embodiments can include many options for the closure mechanism. Perforated interacting (male and female) areas cut into the ends of the strips will be sufficient to provide closure in many, cases.

Embodiments for heavier or larger designs may include applied or printed closure devices including magnetic elements, adhesive areas, mechanically supplied frictional closure (such as Velcro), snap fasteners, studs, hooks, or possibly staples.

Embodiments can be constructed economically on low cost materials using easily accessible and widely available, economical, and high-volume printing and converting techniques.

Embodiments can be made with arbitrary shapes providing a means is provided to ensure closure around the neckwear. In particular embodiments can support arbitrarily sized and shaped body areas onto which promotional or other information can be applied to be visible to a third-party observer when the article is in use.

Embodiments include decorative areas made by applying graphical images by means of printing by any suitable means, such as screen printing, flexographic, offset, gravure , inkjet, or almost any other printing method appropriate to the substrate from which it is made and the intended use of the device.

An embodiment may be built on a substrate which is made up of several thin layers laminated or otherwise bonded together.

Embodiments may have the decorative information presented on either the first or the second surface as appropriate to the materials and the environment.

Embodiment may also have images deposited photographically.

In some embodiments the graphical image or information may extend beyond the body area of the accessory.

An embodiment may be made from rigid material if some processing such as ablation, shaving. planing, etc., is used to allow at least the wing areas to remain flexible, so that the face area looks flat and prominent when the article is in use.

An embodiment may also have additional material laminated or otherwise deposited on all or part of the body area to make that part more rigid than the rest of the article, thus presenting a flatter and more prominent area for the display of the graphical information.

Embodiments may include graphical images and devices which include enhancements such as embossing, debossing, doming, insertion, label application, or pick-and-place application of such an additional accessory, as for example beads.

In some embodiments, articles so applied as embellishments or enhancements can also be functional, such as a flashing or constant LED or other luminescent or electro-luminescent devices, sonic, haptic, or electro- or chemico-articulated elements. They may also include sensors or detectors for identification or security applications.

Embodiments can be designed with arbitrary complexity and include a variety of functional and decorative features, including security and identification features.

The many embodiments of the device can be easily mass produced, are mass customizable, or individually constructed as unique pieces.

Embodiments are generally distinguished from others in the field by consisting in a one-piece construction, thus eliminating complexity, weight, and shipping difficulties.

### DETAILED DESCRIPTION

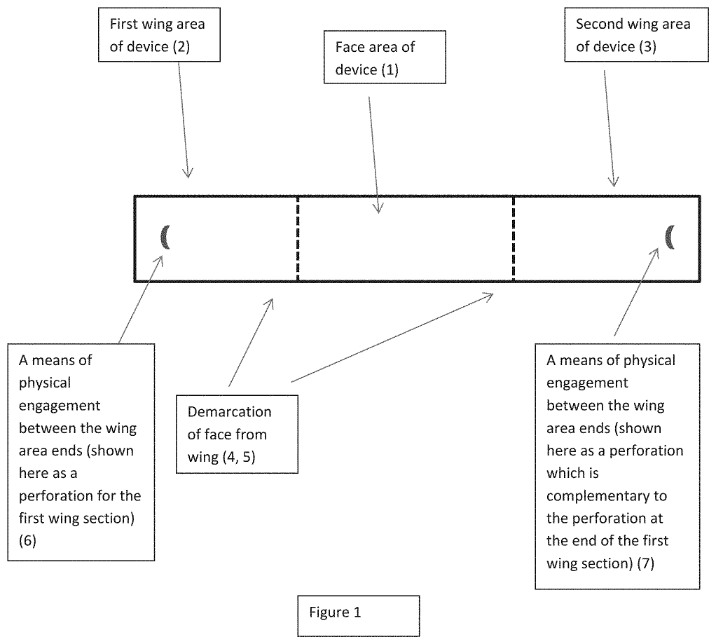

Drawings in FIGS. 1 through 4 are presented to assist in the understanding of the description.

FIG. 1 is a simple elevation view of the simplest embodiment showing the regions of the accessory described as the body area and the wings as an aid to understanding the basic use and function of an embodiment.

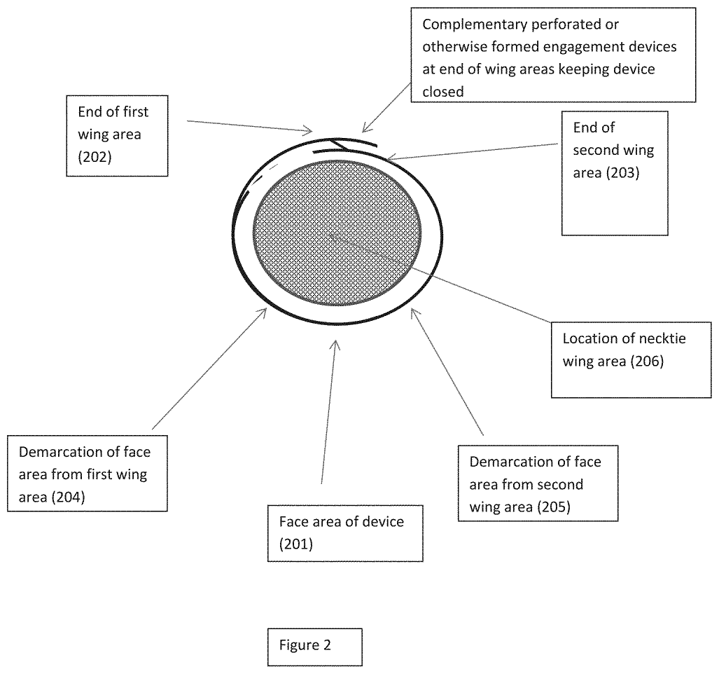

FIG. 2 is a section view of the accessory wrapped around a necktie in the simplest single cavity mode.

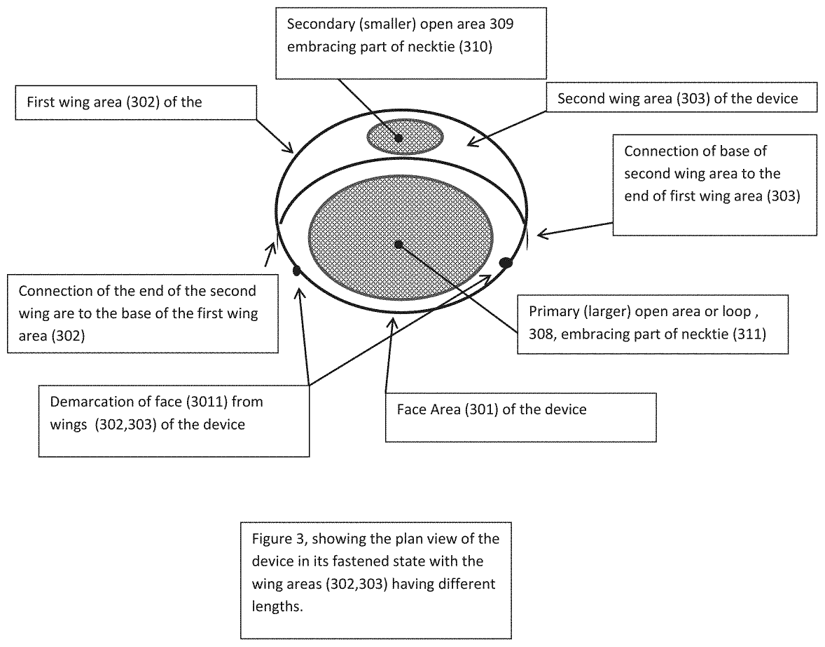

FIG. 3 is a section of the accessory wrapped around a necktie in a two-cavity mode.

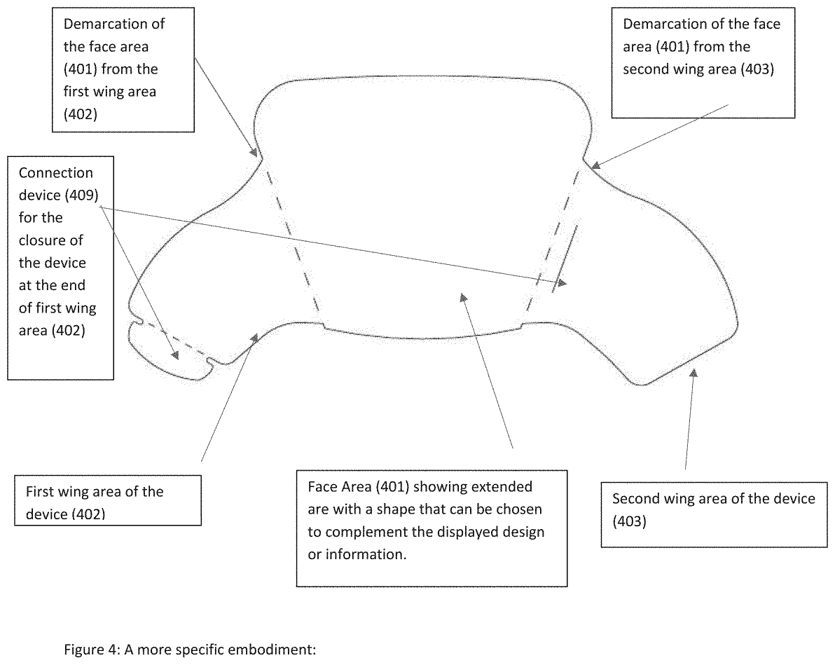

FIG. 4 is an elevation view of an embodiment with an extended body area for presenting decorative material.

In its basic form, the accessory described herein consists of a single piece of flexible substrate as shown for simplicity in FIG. 1 as a simple rectangle, which has three functional sections. The requirements for the substrate are that it is thin and flexible, such as a 0.015″ Melinex or other similar polymer. The material itself may be smooth or textured, opaque, translucent or transparent. There is a body section (or area), (1), a first wing area attached to the body area (2) and a second wing area (3) attached to the body area at a location opposite across the body of the body area to that of the first the first wing section. The demarcations (4, 5) of the body area (1) from the wing areas (2, 3) may be explicit, in the form say of a printed, laminated, or embossed boundary, or may arise from the variation in the width of the device, (see FIG. 4) or can be formed by impressing a crease or perforation at the indicated location, or it can be absent, or can be indicated only or additionally by other features developed on the device through further processing.

Since it is made from a flexible substrate, this device can be bent or curved with a sufficient radius of curvature to wrap around a necktie (typically in the order of 1″ diameter). The ends of the wing sections contain cut or otherwise formed shapes (6, 7) to engage the first wing section with the second wing section so that they interlock easily, but reliably. The length of these sections is chosen so that the entire device, when the ends are interlocked, has a circumference which embraces the necktie with the appropriate tightness to hold the necktie closed and the device in place.

Since the material from which this device is formed begins as a thin flexible substrate, all of the decorative and forming processes available to the modern printer can be used to add value to the device.

The body area (1) can be decorated in many forms. Since it constructed from a thin flexible substrate, many of the decorative arts can be use to apply decoration. For example, in a simple embodiment, the decoration can be printed by any common printing technique, such as screen printing, a printing, ink-jet, offset, or essentially any other printing method appropriate to the surface properties of the material used. Likewise, a decoration can be applied by lamination, by pick and place, by selective deposition, by additive and subtractive processes, as essentially any form of decoration or printed (selectively deposited) functionality can be applied.

Embodiments with high practical value will often have more complex shapes, as shown later in FIG. 4.

The configuration of the accessory when closed and in use is illustrated in FIG. 2, where a view is given of an embodiment of the device, in plan view to illustrate the function of the device, wrapped in a circle and closed. The area 207 represents a section of the necktie to which the device is applied as the necktie passes through the device. The figure shows the closure of the essentially linear structure of the device on itself with the integrated clasp such that it encircles the necktie fabric.

The central area of the wrapped substrate (the body area, 201) is one layer thick and the ends of the substrate overlap each other to make a region which is two layers thick, comprising the ends of the wing areas 204, and 205. Here, a layer is taken to mean one thickness of the constructed, but not assembled accessory, possibly including one or more applied, or printed decorative or functional materials on the substrate. These are held together by a perforated (or other) device to keep the entire device closed (207). There can be one or more perforations depending on the need to adjust or to make a secure connection.

An embodiment of the accessory can have the lengths of the two wing areas the same, or very close, so that after being engaged the arm areas lie close to and on top of each other and form a single thin assembly as shown in FIG. 2. The selection of the substrate and/or the fastening mechanism as well as the length of the wings are made to ensure that when it is at rest the device provides enough friction to hold the tie securely in place.

An embodiment may also have the lengths of the two wing areas made to be different, as shown on FIG. 3. In such an embodiment, the disparate arms, when engaged, will produce an additional open aperture through which one end of the tie or scarf may be threaded while the other end of the tie or scarf is threaded though the other aperture. This has utility not only for dealing with bulky fabrics but also for providing additional friction and thus a faster hold on the fabric. In addition, it may allow the separate ends or other sections of the necktie to remain separated either for function or appearance. A typical use would be to thread the wide end of the tie through the space/slot between the single layer of substrate (which forms the front body of the device when worn) and the middle overlapping portion, and thread the narrow end of the tie between the middle and rear overlapping portion which form the back.

The embodiments described above have been very simple in geometry in order to explain the function. Another embodiment, perhaps more reflective of practical designs may have a more complex shape and present more functional area in the body section of the accessory for display, visual or functional impact, or embellishment while still maintaining the function of the simple rectangular geometry of the embodiments described above. In FIG. 4 such an embodiment is shown. Its shape departs from a simple rectangular form, but retains the characteristic of a body section, two elongated wing sections and appropriate mutually coupling fastener at the farthest extent of the wing areas. In use and in function, the shape illustrated in FIG. 4 will close in the same way as is illustrated in FIGS. 2 and 3. In such an embodiment, demarcation of the wing areas from body will benefit from creasing or perforation to ensure that the fold occurs in a location which permits appropriate closure.

The claims are:

1. An object to wrap around a scarf or necktie in place of, or as a cover for a knot in order to keep the neckwear in place consisting of:
An elongated piece (strip) of clear, opaque, translucent, or transparent flexible substrate having a body area and two wing areas , one on each side of the body area, each wing area having a closure mechanism at its farthest end. The closure mechanism in a simple case being appropriate perforations at end from furthest form the body with complimentary holes and cuts to allow the ends to engage with each other and hold the curved article closed while in use. The elongated substrate is decorated either on its body area alone or on its entire surface to provide a desired appearance as viewed from the outside when the object is in use.

2. The object of claim 1 in which the closure of the furthest ends of the wing areas is achieved by use of an applied or adhered closure mechanism such as snaps, hooks, studs, magnetic elements, Velcro©, staples or other mechanical means.

3. The object of claim 1 in which the body area is larger in dimension than the wing areas and designed to be prominent when in use and on which a specific message is presented either with words or images formed by printing or photography with or without enhancement by doming, embossing, or other graphical enhancement technique.

4. The object of claim 1 in which the body area and wing areas are arbitrary, as long as still functional, and bear promotional information applied by printing or photo deposition and associated enhancement techniques used in the printing and converting industry, which may be complimentary to the shape of the body area.

5. The object of claim 1 in which the demarcation of the wing areas from the body area is made by embossing, creasing, die cutting (kiss cutting), scoring, folding, scribing or thinning in order to ensure proper bending of the wings without distorting the body area.

6. The object of claim 1 in which all or part of the substrate which is made up of several thin layers laminated or otherwise bonded together and in which one or more of the layers may be separately decorated.

7. The object of claim 1 in which the graphical information present is applied to the first or the second surface of the substrate, or is contained on any of the layers used to build up the substrate for the article.

8. The object of claim 1 in which the information o be displayed on the body are is deposited photographically.

9. The object of claim 1 in which the graphical image or information to be displayed may extend beyond the body area of the accessory.

10. The object of claim 1 in which the graphical images and devices include enhancements such as embossing, debossing, doming, insertion, label application, or pick-and-place application of such an additional accessory, as for example beads.

11. The object of claim 1 in which articles applied as embellishments or enhancements to the graphical can also be functional, such as a flashing or constant LED or other luminescent or electro-luminescent devices, sonic, haptic, or electro- or chemico-articulated elements.

12. The object of claim 1 in which articles applied as embellishments or enhancements to the graphical information may also include sensors or detectors for identification, social, or security applications.

13. The object of claim 1 in which the entire substrate is not flexible. but is scored or otherwise processed to allow adequate bending to provide closure for the object to function as if it were flexible.

14. The object of claim 1 in which addition material is deposited by printing, lamination, or other deposition techniques to make the body are more rigid than the rest of the object.
